(19) United States
(12) Patent Application Publication
(10) Pub. No.: US 2019/0257137 A1
(43) Pub. Date: Aug. 22, 2019

(54) DOOR RAMP FOR A PORTABLE BUILDING

(71) Applicant: Joseph Martens, Stonefort, IL (US)

(72) Inventor: Joseph Martens, Stonefort, IL (US)

(21) Appl. No.: 15/901,394

(22) Filed: Feb. 21, 2018

(51) Int. Cl. E06B 3/38; E04B 1/343; E05F 11/04; B65G 69/28

(52) U.S. Cl. CPC E06B 3/38; B65G 69/2811; E05F 11/04; E04B 1/34336

(57) ABSTRACT

An improvement in a portable building (B) comprising a door ramp (10) installed in an opening (O) formed in a sidewall (S) of the building. A ramp door (12) fits in the opening and is hingedly attached to the building. A handle (16) is attached to an exterior surface (12o) of the door allows a user to lower and raise the door with a mechanism (18) facilitating lowering and raising the door in a controlled manner. A panel (32) mounted to the interior top portion of the door extends outwardly as the door is fully lowered to rest on the ground and complete formation of a ramp by items can be brought into or removed from the building.

### CROSS REFERENCE TO RELATED APPLICATIONS

None

### STATEMENT REGARDING FEDERALLY SPONSORED RESEARCH OR DEVELOPMENT

N/A

### BACKGROUND OF THE INVENTION

This invention is directed to portable buildings such as storage sheds, storage barns, etc.; and, more particularly, to a door ramp for use with such structures for moving items into and out of such structures.

Portable storage buildings are structures used as sheds or barns and can range in size from 10′×16′ or smaller, up to 16′×44′ or larger. The buildings are roofed structures constructed of wood and/or metal and can include skids located beneath the building by which the structure is movable from one location to another.

The buildings are used to house or store a variety of items including, for example, lawn and riding mowers, small tractors and other earth moving equipment. The buildings can also serve as workshops for wood, metal working, equipment repair, and hobby crafts, as well as to store tools and various other implements and items. Regardless of the size of the building, it will typically have at least one door and/or window.

A problem with conventional portable structures is the inability to store or house large or heavy pieces of equipment which, like a riding mower, for example, may conveniently fit within the building but which also needs to easily pass through an entryway for the structure. Larger buildings used as garages and barns may have side-by-side hinged door arrangements by which both doors can be pulled open to expose a large enough entryway that a vehicle or large piece of equipment is readily moved into the structure. Garages often have over-head door installations, usually electrically powered, by which a door is raised and lowered to provide an entry into the facility. These conventional arrangements have certain drawbacks with regard to portable structures. For example, portable structures are not necessarily wired for electricity. Also, the framing required to support side-by-side or overhead doors may increase the cost of fabricating the structure so it is not as economical as it could be.

### BRIEF SUMMARY OF THE INVENTION

The present disclosure is directed to a ramp door for use with portable buildings. In a raised, closed position, the door cover covers an opening formed in the side of a portable building, the opening being sufficiently large for items to be stored in the structure to be readily moved or driven into the building. In an extended, lowered position, the door ramp provides an angled or sloping surface by which items can be readily carried, loaded, or driven into, or out of, the structure.

The ramp door is hingedly connected to the structure to lower and raise the door and a mechanism is provided by which a user can do so in a controlled manner. A panel is mounted to the interior top portion of the door and extends outwardly as the door is fully lowered to rest on the ground and complete formation of a ramp by which items can be brought into or removed from the building.

In use, the ramp door can be easily opened and closed by a minimum number of people to provide access to the building.

The ramp door is a permanent part of the building and does not have to be removed if the building is relocated.

The ramp door is of a wood and/or metal and/or fiberglass construction and is reinforced, if necessary, depending upon the items being stored in the portable building.

Other objects and features will be in part apparent and in part pointed out hereinafter.

### BRIEF DESCRIPTION OF THE SEVERAL VIEWS OF THE DRAWINGS

The accompanying figures, together with detailed description which follows, form part of the specification and illustrate the various embodiments described in the specification.

FIG. 1 is an elevation view of one side of portable building in which a ramp door of the present invention is installed;

FIG. 2 is a partial side view of the building illustrating lowering and raising of the ramp door;

FIG. 3 is view of the building illustrating the ramp door in a partially lowered or raised position; and,

FIG. 4 is a view from the interior of the building illustrating the ramp door in a partially lowered or raised position.

Corresponding reference characters indicate corresponding parts throughout the several views of the drawings.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Referring to the drawings, a portable building B includes sidewalls S, a roof R, a floor F (see FIG. 4), and a plurality of skids K installed beneath the floor and on which the building rests. The skids are used when the portable building is towed from one site to another. As previously noted portable building B is available in various sizes and is used for a variety of purposes. The building is of a post and beam construction (not described) and is made of wood and/or metal. The building typically has at least one door and window which are not shown in the drawings.

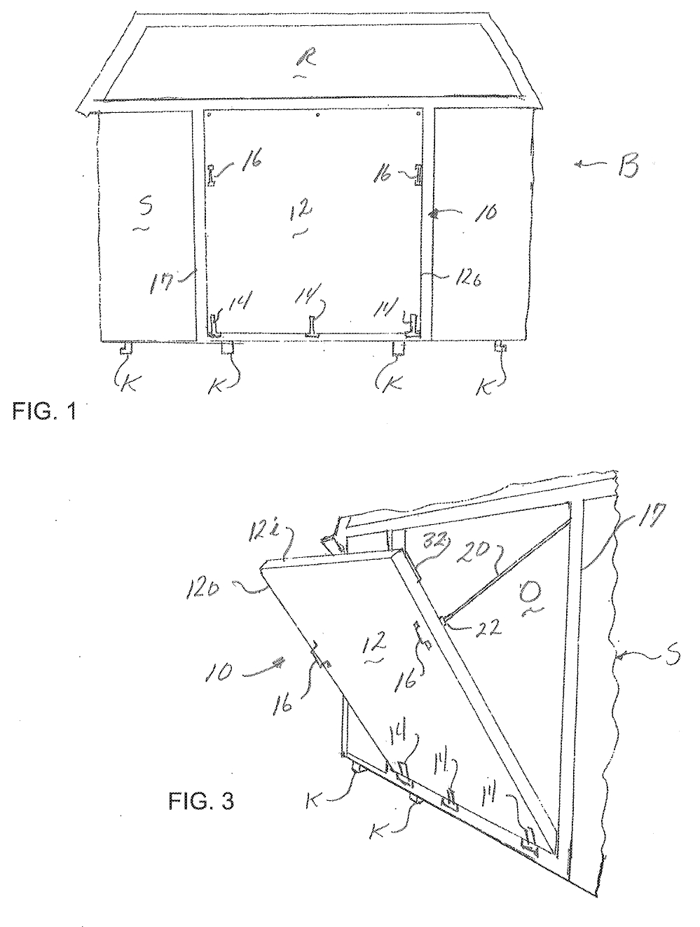

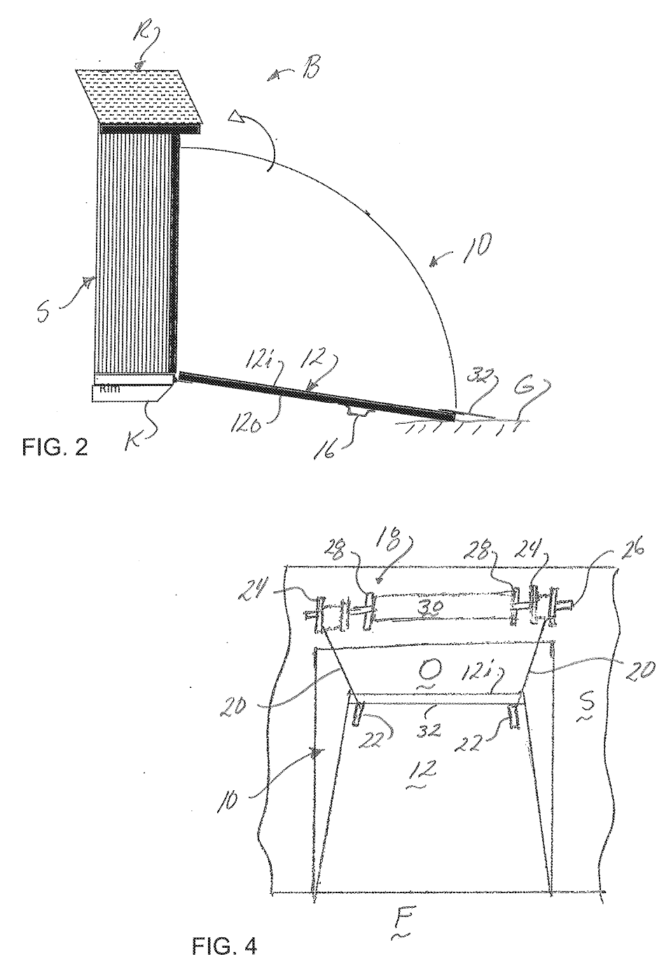

An improvement to portable building B comprises a door ramp indicated generally 10 and which is installed in an opening O (see FIGS. 3 and. 4) formed in one of the sidewalls S. Door ramp 10 includes a generally rectangular shaped door 12 sized to fit in opening O and close the opening when the door is in a raised position (see FIG. 1). The door is made of wood or metal or fiberglass or a combination of these materials. While construction of door 12 is not described, those skilled in the art will appreciate that the door can be a reinforced door to accommodate the storing or removal of heavy or bulky items.

To raise and lower door 12, the base of the door is hingedly attached to the sidewall in which opening O is formed, the bottom of the door being hinged to a frame piece 17 adjacent floor F. As shown in FIG. 1, inverted T-shaped hinges 14 connect the base of door 12 with door frame 17, three such hinges being used for this purpose. Two of the hinges are adjacent the sides of the door with the third hinge being in the middle. The mounting of door ramp 12 is such that door pivots approximately 6″-12″ off the bottom of the skids K.

Two handles 16 are attached to the outer surface of door 12 along opposites of the door. The handles are attached to the exterior or outer face 120 of the door at a height that allows one or two people to each conveniently grasp a handle and pull on it to lower or open door 12, or push on it to raise the door back to its closed position.

A mechanism indicated generally 18 allows door 12 to be lowered and raised in a controlled manner. One end of a rope/chain/wire 20 is connected to the interior or inner face 12i of the door, on opposite sides of the door as shown in FIG. 4, by a bracket 22. Each rope/chain/wire is routed through a spool 24. There are two such spools each of which are respectively mounted on opposite ends of a rod 26 that extends across the top of opening O, above the opening. Rod 26 is rotatably supported by brackets 28 that attach to the interior face of sidewall S above the door opening. Mounted on rod 26 between the spools is a torsion spring 30 to facilitate lowering and raising door 12 by mechanism 18. As shown in FIG. 2, operation of mechanism 18 is such that when door 12 is fully lowered, the upper end of the door rests on the ground G with the other end of the door remaining adjacent floor F, thereby to form a ramp by which an item can easily be brought into or removed from portable building B.

In this latter regard, the improvement of the present invention further includes a panel 32 which extends across the width of door ramp 12. Panel 32 is hinged to the top of the door as shown in FIG. 4, and as the ramp door is lowered rotates outwardly or “flips-out” to complete formation of the ramp. That is, when door ramp 12 is fully lowered as shown in FIG. 2, panel 32 is extended outwardly from the top of the door with its outer end resting on the ground. This then makes for a smooth transition (no offset) between the ground and the ramp that is formed by the door, so there is no abrupt transition for articles being moved onto or off the ramp. Further, the panel helps counter any unevenness in the ground surface between the sides of door 12 when in its lowered position. Accordingly, in its extended, lowered position, door ramp 12 provides an angled or sloping surface up which items can be readily carried, loaded, or driven into, or out of, building B.

This feature helps prevent damage to items being stored or removed from potable building B by eliminating any bumps which might otherwise occur; or skewing of items because of any differences in heights between one side of the ramp and the other when the door is in its lowered position.

In view of the above, it will be seen that the several objects and advantages of the present disclosure have been achieved and other advantageous results have been obtained.

Having thus described the invention, what is claimed and desired to be secured by Letters Patent is:

1. In a portable building comprising sidewalls, a roof, a floor, and a plurality of skids installed beneath the floor and on which the building rests, the improvement comprising a door ramp installed in an opening formed in one of the sidewalls and including:
a generally rectangular single piece shaped door sized to fit in the opening and close the opening when the door is in a raised position, the base of the door being hingedly attached to the sidewall adjacent the floor;
at least one handle attached to an exterior surface of the door for grasping by a user to lower and raise the door;
means attached to an interior surface of the door for enabling the door to be lowered and raised in a controlled manner whereby when the door is fully lowered, one end of the door rests on the ground with the other end of the door being adjacent the floor thereby to form a ramp by which an item can be brought into or removed from the building; and,
a panel hingedly connected to an interior surface of the door adjacent the top of the door, the panel extending outwardly as the door is lowered to its fully lowered position so to provide for a smooth transition for the items as they are brought onto or removed from the buildings using the door ramp.

2. The improvement of claim 1 wherein said means comprises one end of a rope or chain or wire connected to an inner face of the door on at least one side of the door.

3. The improvement of claim 2 wherein said means includes a bracket attached to the inner face of the door for attaching the one end of the rope or chain or wire.

4. The improvement of claim 3 wherein said means further includes a rod extending across the top of the opening, above the opening, and on which is mounted a spool to which one end of the rope or chain or wire is attached.

5. The improvement of claim 4 in which the rod is rotatably supported by brackets that attach to an interior face of the sidewall above the door opening.

6. The improvement of claim 5 wherein said means further includes a torsion spring.

7. The improvement of claim 1 wherein the door is a reinforced door for facilitating movement of large or bulky items.

8. In a portable building comprising sidewalls, a roof, a floor, and a plurality of skids installed beneath the floor and on which the building rests, the improvement comprising a door ramp installed in an opening formed in one of the sidewalls and including:
a generally rectangular shaped single piece door sized to fit in the opening and close the opening when the door is in a raised position, the base of the door being hingedly attached to the sidewall adjacent the floor using a plurality of spaced apart hinges installed at the base of the door on an exterior surface of the door;
at least one handle attached to an exterior surface of the door for grasping by a user to lower and raise the door;
means attached to an interior surface of the door for enabling the door to be lowered and raised in a controlled manner whereby when the door is fully lowered, one end of the door rests on the ground with the other end of the door being adjacent the floor thereby to form a ramp by which an item can be brought into or removed from the building; and,
a panel hingedly connected to an interior surface of the door adjacent the top of the door, the panel extending outwardly as the door is lowered to its fully lowered position so to provide for a smooth transition for the items as they are brought onto or removed from the buildings using the door ramp.

9. The improvement of claim 8 wherein the hinges comprise a plurality of T-shaped hinges with one hinge installed in the center of the door and with a hinge installed adjacent each side of the door.

10. The improvement of claim 9 in which the hinges are inverted for the base of the hinge to be attached to the sidewall immediately below a lower edge of the door with the leg of each hinge extending upwardly along the exterior surface of the door.
